(19) United States
(12) Patent Application Publication
(10) Pub. No.: US 2025/0381570 A1
(43) Pub. Date: Dec. 18, 2025

(54) METAL PURIFICATION DEVICE AND METHOD BASED ON MASS-TO-CHARGE RATIO DIFFERENCE

(71) Applicant: Shanghai University, Shanghai (CN)

(72) Inventors: Xiaoxin Zhang, Shanghai (CN); Zhirui Tian, Shanghai (CN); Hao Xue, Shanghai (CN); Zhongming Ren, Shanghai (CN)

(73) Assignee: Shanghai University, Shanghai (CN)

(21) Appl. No.: 19/215,024

(22) Filed: May 21, 2025

(30) Foreign Application Priority Data
Jun. 18, 2024 (CN) 202410792021.5

(51) Int. Cl. B03C 1/023; H01J 49/00; H01J 49/24; H01J 49/28

(52) U.S. Cl. CPC B03C 1/023; H01J 49/0031; H01J 49/24; H01J 49/284

(57) ABSTRACT

Provided is a metal purification device and method based on a mass-to-charge ratio difference. The metal purification device includes a vacuum chamber, and an ion excitation chamber and an electromagnetic separation chamber that are arranged in the vacuum chamber. The ion excitation chamber and the electromagnetic separation chamber are arranged side by side. The vacuum chamber is configured to provide a vacuum purification environment or an inert gas-filled purification environment. The ion excitation chamber is configured to excite an impurity-containing metal sample to produce ionized atoms with different mass-to-charge ratios. A plurality of collectors are provided in the electromagnetic separation chamber, and the electromagnetic separation chamber is configured to provide an electric field and a magnetostatic field. Electric field forces generated by the electric field cooperate with Lorentz forces generated by the magnetostatic field to control the ionized atoms with the different mass-to-charge ratios to enter different collectors.

### CROSS REFERENCE TO RELATED APPLICATION

This patent application claims the benefit and priority of Chinese Patent Application No. 2024107920215, filed with the China National Intellectual Property Administration on Jun. 18, 2024, the disclosure of which is incorporated by reference herein in its entirety as part of the present application.

### TECHNICAL FIELD

The present application relates to the technical field of metal purification, and in particular relates to a metal purification device and method based on a mass-to-charge ratio difference.

### BACKGROUND

High-purity metals are essential basic raw materials for high-tech fields such as microelectronics, photovoltaics, communications, and nuclear power. With the rapid development of these high-tech fields, the demand for high-purity metals has been increasing, and the advanced requirements have been put forward for purification technologies to meet the needs of production efficiency and quality. This trend poses a huge challenge to the existing purification technologies.

Currently, the common technical principles of metal purification are as follows: 1) sieving or adsorption; 2) density difference; 3) electromagnetic extrusion force; 4) solubility difference; 5) electric potential difference; 6) vapor pressure difference; 7) chemical activity difference; and 8) intensity difference of collision between atom and carrier. However, the above-mentioned purification technologies all have respective limitations. The purification technologies based on the principles of sieving or adsorption, density difference, and electromagnetic extrusion force only play a role in the separation of large-size inclusions, but have a poor separation effect for small-size inclusions and impurity elements. The purification technologies based on the principles of electric potential difference, vapor pressure difference, and chemical activity difference are the major purification technologies currently applied, but these technologies generally exhibit poor removal effect for interstitial impurity elements. The purification technologies based on the principles of chemical activity difference and an intensity difference of collision between atoms and carrier are only effective for the removal of interstitial impurity elements, but exhibit poor removal effect for inclusions and other impurity elements. Moreover, the purification technologies based on the principles of chemical activity difference and intensity difference of collision between atom and carrier are generally time-consuming and energy-intensive and have low yield. Therefore, the current preparation of high-purity metals often requires the combination of various purification technologies, which has the defects of long process, high cost, and low yield, can only lead to limited ultimate purity for many active metals, and is difficult to meet the new requirements of modern industrial technologies for the preparation of high-purity metals.

### SUMMARY

An objective of the present application is to provide a metal purification device and method based on a mass-to-charge ratio difference, which can effectively separate and remove any impurity elements and inclusions to improve the purity of a metal and achieve the efficient purification. To achieve the above objective, the present application provides the following solutions:

In a first aspect, the present application provides a metal purification device based on a mass-to-charge ratio difference, including: a vacuum chamber, and an ion excitation chamber and an electromagnetic separation chamber that are arranged in the vacuum chamber,
where the ion excitation chamber and the electromagnetic separation chamber are arranged side by side;
the vacuum chamber is configured to provide a vacuum purification environment or an inert gas-filled purification environment;
the ion excitation chamber is configured to excite an impurity-containing metal sample to produce ionized atoms with different mass-to-charge ratios; and
a plurality of collectors are set in the electromagnetic separation chamber, and the electromagnetic separation chamber is configured to provide an electric field and a magnetostatic field; the electric field is provided to apply electric field forces to the ionized atoms with the different mass-to-charge ratios, and the magnetostatic field is provided to apply Lorentz forces to the ionized atoms with the different mass-to-charge ratios; and the electric field forces cooperate with the Lorentz forces to control the ionized atoms with the different mass-to-charge ratios to enter different collectors.

In a second aspect, the present application provides a metal purification method based on a mass-to-charge ratio difference, where the metal purification method is applied to the metal purification device described above, and includes:
constructing a high-vacuum purification environment or an inert gas-filled purification environment by the vacuum chamber;
placing an impurity-containing metal sample in the ion excitation chamber, and exciting the impurity-containing metal sample by the ion excitation chamber to produce ionized atoms with different mass-to-charge ratios; and
applying an electric field and a magnetostatic field to the ionized atoms with the different mass-to-charge ratios, and controlling the ionized atoms with the different mass-to-charge ratios to enter different collectors through cooperation of electric field forces and Lorentz forces.

According to specific embodiments provided by the present application, the present application discloses the following technical effects:
The present application provides a metal purification device and method based on a mass-to-charge ratio difference. The metal purification device includes a vacuum chamber, and an ion excitation chamber and an electromagnetic separation chamber that are arranged in the vacuum chamber. The ion excitation chamber and the electromagnetic separation chamber are arranged side by side. The vacuum chamber is configured to provide a vacuum purification environment or an inert gas-filled purification environment. The ion excitation chamber is configured to excite an impurity-containing metal sample to produce ionized atoms with different mass-to-charge ratios. A plurality of collectors is set in the electromagnetic separation chamber, and the electromagnetic separation chamber is configured to provide an electric field and a magnetostatic field. The electric field is provided to apply electric field forces to the ionized atoms with different mass-to-charge ratios, and the magnetostatic field is provided to apply Lorentz forces to the ionized atoms with the different mass-to-charge ratios. The electric field forces cooperate with the Lorentz forces to control the ionized atoms with the different mass-to-charge ratios to enter different collectors. In the present application, an impurity-containing metal sample is excited by the ion excitation chamber to produce ionized atoms with different mass-to-charge ratios, and then these ionized atoms are separated through the electric field and the magnetostatic field of the electromagnetic separation chamber. Because the mass-to-charge ratios of impurities are different from the mass-to-charge ratio of pure metal, ionized atoms representing the impurities and ionized atoms representing the pure metal enter different collectors, such that any impurity elements and inclusions can be effectively removed to improve the purity of the metal. Moreover, compared with the combination of a plurality of purification technologies to prepare a high-purity metal in the prior art, the device designed in the present application involves a simple process and can achieve the efficient metal purification.

### BRIEF DESCRIPTION OF THE DRAWINGS

To describe the technical solutions in the embodiments of the present application or in the prior art clearly, the accompanying drawings required for the embodiments are briefly described below. Apparently, the accompanying drawings in the following description show merely some embodiments of the present application, and those of ordinary skill in the art may still derive other accompanying drawings from these accompanying drawings without creative efforts.

FIG. 1 is a schematic diagram of a structure of the metal purification device in Example 1 of the present application; and

FIG. 2 is a schematic diagram of a structure of the metal purification device in Example 2 of the present application.

### DETAILED DESCRIPTION OF THE EMBODIMENTS

The technical solutions in the embodiments of the present application are clearly and completely described below with reference to the accompanying drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

To make the above objectives, features, and advantages of the present application clear and comprehensible, the present application will be further described in detail below with reference to the accompanying drawings and specific implementations.

### Example 1

This example provides a metal purification device based on a mass-to-charge ratio difference. The metal purification device includes a vacuum chamber, and an ion excitation chamber and an electromagnetic separation chamber that are arranged in the vacuum chamber. The ion excitation chamber and the electromagnetic separation chamber are arranged side by side. The vacuum chamber is configured to provide a vacuum purification environment or an inert gas-filled purification environment. The ion excitation chamber is configured to excite an impurity-containing metal sample to produce ionized atoms with different mass-to-charge ratios. A plurality of collectors are provided in the electromagnetic separation chamber, and the electromagnetic separation chamber is configured to provide an electric field and a magnetostatic field. The electric field is provided to apply electric field force to the ionized atoms with the different mass-to-charge ratios, and the magnetostatic field is provided to apply Lorentz forces to the ionized atoms with the different mass-to-charge ratios. The electric field forces cooperate with the Lorentz forces to control the ionized atoms with the different mass-to-charge ratios to enter different collectors.

Further, positions of the plurality of collectors are adjusted and determined according to the mass-to-charge ratios of the ionized atoms, an intensity and a direction of the electric field, and an intensity and a direction of the magnetostatic field.

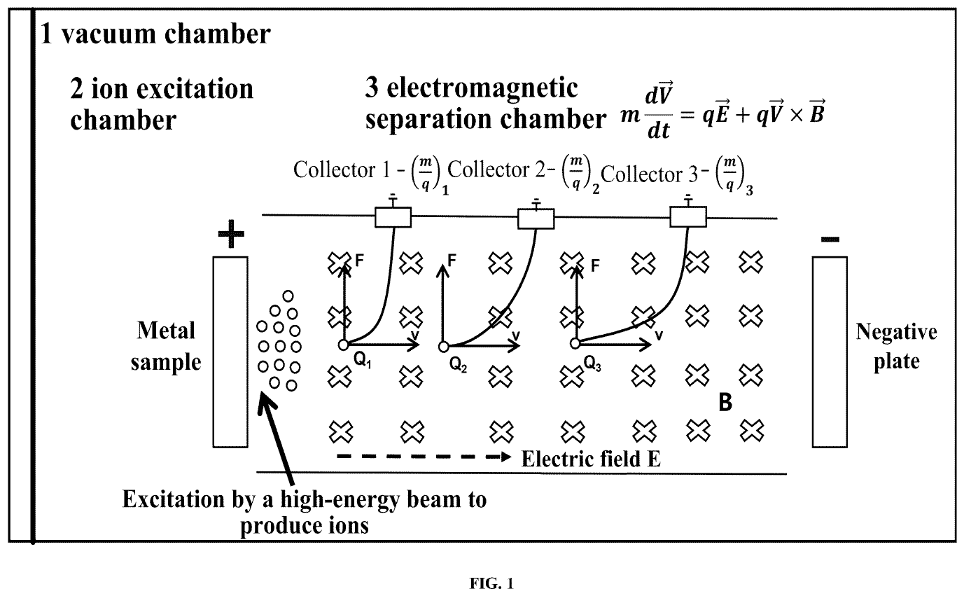

Further, the electromagnetic separation chamber has a chamber structure. An inner wall of one side of the chamber structure is provided with a negative plate, and the plurality of collectors are arranged on an inner wall of another side of the chamber structure. The inner wall of the one side is adjacent to the inner wall of the other side. When the impurity-containing metal sample is a positive plate, the negative plate is arranged corresponding to the positive plate, and a uniform electric field in a horizontal direction is formed. For example, when the impurity-containing metal sample is aluminum, the metal sample of aluminum is set as a positive plate, and the positive plate is arranged corresponding to the negative plate. Moreover, a direction of the magnetostatic field is perpendicular to a direction of the electric field. The excited ionized atoms move towards the negative plate under the electric field force and are deflected under an action of the Lorentz forces generated by the magnetostatic field, and a corresponding motion equation meets m(d\vec{V})/dt=q\vec{E}+q\vec{V}×\vec{B} According to this motion equation, ionized atoms with different mass-to-charge ratios (m/q) will be deposited in different collectors, such as collectors 1, 2, and 3, such that the metal sample of aluminum can be separated and purified. A purity of the prepared high-purity aluminum is as high as 5N or higher. A schematic diagram of the structure in this example is shown in FIG. 1.

### Example 2

This example provides another metal purification device based on a mass-to-charge ratio difference. This metal purification device further includes an electric field acceleration chamber. The electric field acceleration chamber is arranged between the ion excitation chamber and the electromagnetic separation chamber. The electric field acceleration chamber is configured to accelerate the ionized atoms.

Further, the electromagnetic separation chamber is divided into a plurality of stages of separation chambers (such as a first-stage separation chamber and a second-stage separation chamber). A small hole for the ionized atoms to pass through is designed between two adjacent stages of separation chambers. An intensity and a direction of an electric field and an intensity and a direction of a magnetostatic field of each stage of separation chamber are determined according to the mass-to-charge ratios of the ionized atoms that need to be collected.

Further, an upper end or a lower end of each stage of separation chamber is correspondingly provided with one of the plurality of collectors.

Further, when the impurity-containing metal sample is a metal sample of 4N-purity aluminum, the metal sample of 4N-purity aluminum is placed in the ion excitation chamber, and excited by a high-energy beam to produce a large number of ionized atoms. The excited ionized atoms are accelerated in the electric field acceleration chamber to produce kinetic energy, and the kinetic energy is related to an acceleration voltage U. The kinetic energy is as follows:

$$qU = \frac{1}{2} {mv}^{2} .$$

The accelerated ionized atoms enter the electromagnetic separation chamber. The first-stage separation chamber is provided with a magnetic field and an electric field in a perpendicular direction to the magnetic field. The second-stage separation chamber is merely provided with a magnetic field. Intensities of the magnetic fields of the two magnetic field separation chambers are controlled independently. A magnetic field intensity B and an electric field intensity E of the first-stage separation chamber are adjusted, such that electric field forces and Lorentz forces experienced by trivalent aluminum ionized atoms in the first-stage separation chamber are allowed to be equal, that is, qVB=EB. In this case, only the trivalent aluminum ionized atoms can successfully enter the second-stage separation chamber through a small hole of the first-stage separation chamber, and other impurity ions all are deflected in the first-stage separation chamber and enter the corresponding collector in the first-stage separation chamber to achieve the separation. Finally, the trivalent aluminum ionized atoms entering the second-stage separation chamber are deflected under the action of the Lorentz forces, enter the corresponding collector in the second-stage separation chamber, and are deposited, with a deflection radius of

$$r = \frac{m}{q} \frac{v}{B} .$$

### That is,

$$r = \frac{\sqrt{2 U}}{B} \sqrt{\frac{m}{q}} .$$

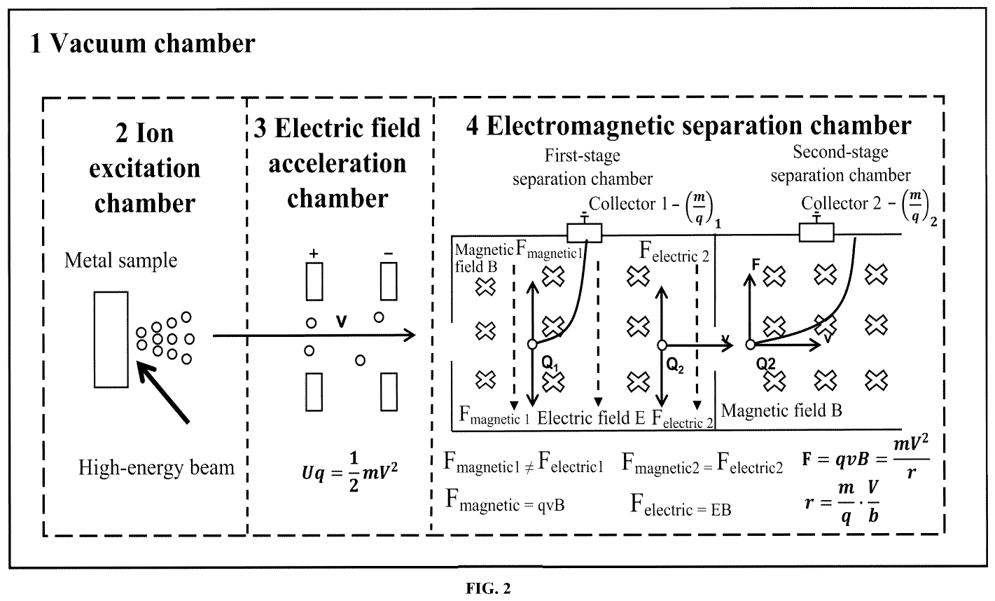

A purity of the prepared high-purity aluminum also reaches 5N or higher. A schematic diagram of a structure in this example is shown in FIG. 2.

Further, a material of the plurality of collectors includes conductive refractory metals and ceramics. A structure of the plurality of collectors includes a flat plate, a cylinder, and a square barrel. Moreover, the temperatures of the plurality of collectors can be adjusted. A mode for the adjusting includes, but is not limited to, various cooling modes such as natural cooling, water cooling, and air cooling and various heating modes such as resistance heating and induction heating.

### Example 3

This example provides a metal purification method based on a mass-to-charge ratio difference. The metal purification method is applied to the metal purification device based on a mass-to-charge ratio difference described above. The metal purification method includes: A high-vacuum purification environment or an inert gas-filled purification environment is constructed by the vacuum chamber. An impurity-containing metal sample is placed in the ion excitation chamber and excited by the ion excitation chamber to produce ionized atoms with different mass-to-charge ratios. An electric field and a magnetostatic field are applied to the ionized atoms with the different mass-to-charge ratios, and the ionized atoms with the different mass-to-charge ratios are controlled to enter different collectors through cooperation of electric field forces and Lorentz forces. A mode for exciting the impurity-containing metal sample includes heating-lead excitation, laser-lead excitation, plasma beam-lead excitation, and electron beam-lead excitation. The magnetostatic field is a magnetic field generated by a permanent magnet or an energized coil.

According to the physics principles, a ratio of the mass to the charge of an atom in an ionic state (mass-to-charge ratio) varies greatly among different types of atoms. When an ion moves in the magnetostatic field, the motion direction will be changed due to the action of the Lorentz force, and the angle of a direction change under a specified motion speed and magnetic field is related to the mass-to-charge ratio of the ion. Based on the difference in the deflection angle, various atoms can be completely separated. Based on this principle, the present disclosure provides a metal purification method for separating and removing impurities in a metal. Since all atoms in a metal to be purified experience this process, each atom is screened without exception and each impurity atom is separated. Therefore, a purity of a metal produced can be theoretically close to 100%, which achieves the extremely-high level of purification.

In addition, for inclusions in a metal, if the inclusions can be dissociated, the inclusions are separated in ionic form. If the inclusions cannot be dissociated, the inclusions will not be affected by an electromagnetic force and thus will remain in the raw material, which also achieves a separation effect.

The technical features of the above embodiments can be arbitrarily combined. For brevity of description, not all possible combinations of the technical features of the above embodiments are described. However, any combinations of these technical features should be construed as falling within the scope defined by the specification as long as there is no contradiction among the combinations.

Specific examples are used herein for illustration of the principles and implementations of the present application. The description of the above embodiments is merely intended to help understand the method of the present application and the core concept thereof. In addition, those of ordinary skill in the art can make various modifications in terms of specific implementations and an application scope in accordance with the teachings of the present application. In conclusion, the content of the specification shall not be construed as a limitation to the present application.

What is claimed is:

1. A metal purification device based on a mass-to-charge ratio difference, comprising: a vacuum chamber, and an ion excitation chamber and an electromagnetic separation chamber that are arranged in the vacuum chamber,
wherein the ion excitation chamber and the electromagnetic separation chamber are arranged side by side;
the vacuum chamber is configured to provide a vacuum purification environment or an inert gas-filled purification environment;
the ion excitation chamber is configured to excite an impurity-containing metal sample to produce ionized atoms with different mass-to-charge ratios; and
a plurality of collectors are provided in the electromagnetic separation chamber, and the electromagnetic separation chamber is configured to provide an electric field and a magnetostatic field; the electric field is provided to apply electric field forces to the ionized atoms with the different mass-to-charge ratios, and the magnetostatic field is provided to apply Lorentz forces to the ionized atoms with the different mass-to-charge ratios; and the electric field forces cooperate with the Lorentz forces to control the ionized atoms with the different mass-to-charge ratios to enter different collectors.

2. The metal purification device based on a mass-to-charge ratio difference according to claim 1, wherein positions of the plurality of collectors are adjusted and determined according to the mass-to-charge ratios of the ionized atoms, an intensity and a direction of the electric field, and an intensity and a direction of the magnetostatic field.

3. The metal purification device based on a mass-to-charge ratio difference according to claim 1, wherein the electromagnetic separation chamber has a chamber structure; an inner wall of one side of the chamber structure is provided with a negative plate, and the plurality of collectors are arranged on an inner wall of another side of the chamber structure; the inner wall of the one side is adjacent to the inner wall of the another side; and when the impurity-containing metal sample is a positive plate, the negative plate is arranged corresponding to the positive plate, and therefore a uniform electric field in a horizontal direction is formed.

4. The metal purification device based on a mass-to-charge ratio difference according to claim 1, further comprising an electric field acceleration chamber, wherein the electric field acceleration chamber is arranged between the ion excitation chamber and the electromagnetic separation chamber, and the electric field acceleration chamber is configured to accelerate the ionized atoms.

5. The metal purification device based on a mass-to-charge ratio difference according to claim 1, wherein the electromagnetic separation chamber is divided into a plurality of stages of separation chambers, a small hole for the ionized atoms to pass through is formed between two adjacent stages of separation chambers, and an intensity and a direction of an electric field and an intensity and a direction of a magnetostatic field of each stage of separation chamber are determined according to the mass-to-charge ratios of the ionized atoms that need to be collected.

6. The metal purification device based on a mass-to-charge ratio difference according to claim 5, wherein an upper end or a lower end of each stage of separation chamber is correspondingly provided with one of the plurality of collectors.

7. The metal purification device based on a mass-to-charge ratio difference according to claim 1, wherein a material of the plurality of collectors comprises conductive refractory metals and ceramics; and a structure of the plurality of collectors comprises a flat plate, a cylinder, and a square barrel.

8. A metal purification method based on a mass-to-charge ratio difference, wherein the metal purification method is applied to the metal purification device based on a mass-to-charge ratio difference according to claim 1, and comprises:
constructing a high-vacuum purification environment or an inert gas-filled purification environment by the vacuum chamber;
placing an impurity-containing metal sample in the ion excitation chamber, and exciting the impurity-containing metal sample by the ion excitation chamber to produce ionized atoms with different mass-to-charge ratios; and
applying an electric field and a magnetostatic field to the ionized atoms with the different mass-to-charge ratios, and controlling the ionized atoms with the different mass-to-charge ratios to enter different collectors through cooperation of electric field forces and Lorentz forces.

9. The metal purification method based on a mass-to-charge ratio difference according to claim 8, wherein a mode for exciting the impurity-containing metal sample comprises heating excitation, laser-lead excitation, plasma beam-lead excitation, and electron beam-lead excitation.

10. The metal purification method based on a mass-to-charge ratio difference according to claim 9, wherein the magnetostatic field is a magnetic field generated by a permanent magnet or an energized coil.

11. The metal purification method based on a mass-to-charge ratio difference according to claim 8, wherein positions of the plurality of collectors are adjusted and determined according to the mass-to-charge ratios of the ionized atoms, an intensity and a direction of the electric field, and an intensity and a direction of the magnetostatic field.

12. The metal purification method based on a mass-to-charge ratio difference according to claim 8, wherein the electromagnetic separation chamber has a chamber structure; an inner wall of one side of the chamber structure is provided with a negative plate, and the plurality of collectors are arranged on an inner wall of another side of the chamber structure; the inner wall of the one side is adjacent to the inner wall of the another side; and when the impurity-containing metal sample is a positive plate, the negative plate is arranged corresponding to the positive plate, and therefore a uniform electric field in a horizontal direction is formed.

13. The metal purification method based on a mass-to-charge ratio difference according to claim 8, further comprising an electric field acceleration chamber, wherein the electric field acceleration chamber is arranged between the ion excitation chamber and the electromagnetic separation chamber, and the electric field acceleration chamber is configured to accelerate the ionized atoms.

14. The metal purification method based on a mass-to-charge ratio difference according to claim 8, wherein the electromagnetic separation chamber is divided into a plurality of stages of separation chambers, a small hole for the ionized atoms to pass through is formed between two adjacent stages of separation chambers, and an intensity and a direction of an electric field and an intensity and a direction of a magnetostatic field of each stage of separation chamber are determined according to the mass-to-charge ratios of the ionized atoms that need to be collected.

15. The metal purification method based on a mass-to-charge ratio difference according to claim 14, wherein an upper end or a lower end of each stage of separation chamber is correspondingly provided with one of the plurality of collectors.

16. The metal purification method based on a mass-to-charge ratio difference according to claim 8, wherein a material of the plurality of collectors comprises conductive refractory metals and ceramics; and a structure of the plurality of collectors comprises a flat plate, a cylinder, and a square barrel.
